(19) United States
(12) Patent Application Publication
(10) Pub. No.: US 2011/0154213 A1
(43) Pub. Date: Jun. 23, 2011

(54) METHOD AND APPARATUS FOR PRESENTING CONTENT DOWNLOAD PROGRESS

(75) Inventors: Mark Wheatley, Bristol (GB); Craig Pugsley, Devon (GB)

(73) Assignee: Nokia Corporation, Espoo (FI)

(21) Appl. No.: 12/641,979

(22) Filed: Dec. 18, 2009

(51) Int. Cl. G06F 3/01; G06F 3/048

(52) U.S. Cl. 715/738; 715/772

(57) ABSTRACT

Techniques for presenting content download progress include determining a plurality of layers of information about a specific download of particular content to an apparatus. The information in the plurality of layers is different from an amount of the particular content. The particular content is caused to be stored progressively into a memory on the apparatus. A first layer of information is presented on the local device upon a start of the specific download. An amount of the particular content stored into the memory is determined. A different second layer of information is presented progressively on the local device during the specific download based on the amount of the particular content stored into the memory.

### BACKGROUND

Service providers and device manufacturers are continually challenged to deliver value and convenience to consumers by, for example, providing compelling network services and advancing the underlying technologies. One area of interest has been the development of services and technologies for sharing content (e.g., music) and related information across a variety of platforms (e.g., mobiles devices, fixed terminals) and scenarios (e.g., location of devices, connectivity capabilities, etc.). These applications often involve downloading the content from a remote server to a local device for the user. Depending on the size of the content file, the number of files, and the smallest bandwidth of the connection between the network and either the local device or the remote server, the content can take several seconds to tens of minutes to completely download. The wait for the completed download is often unpleasant for the user, thus leading to a diminished user experience.

### Some Example Embodiments

Therefore, there is a need for an approach for improving the user experience by presenting content download progress using multiple information layers peculiar to the download.

According to one embodiment, a method comprises determining a plurality of layers of information about a specific download of particular content to a local device. The information in the plurality of layers is different from an amount of the particular content. The method also comprises causing the particular content to be stored progressively into a memory on the local device. The method also comprises causing a first layer of information to be presented on the local device upon a start of the specific download. The method also comprises determining an amount of the particular content stored into the memory. The method further comprises causing a different second layer of information to be presented progressively on the local device during the specific download based on the amount of the particular content stored into the memory.

According to another embodiment, an apparatus comprising at least one processor, and at least one memory including computer program code, the at least one memory and the computer program code configured to, with the at least one processor, cause, at least in part, the apparatus to determine a plurality of layers of information about a specific download of particular content to the apparatus. The information in the plurality of layers is different from an amount of the particular content. The apparatus is also caused to cause the particular content to be stored progressively into the at least one memory. The apparatus is also caused to initiate presentation of a first layer of information to be presented upon a start of the specific download. The apparatus is also caused to determine an amount of the particular content stored into the at least one memory. The apparatus is further caused to initiate presentation progressively of a different second layer of information during the specific download based on the amount of the particular content stored into the at least one memory.

According to another embodiment, a computer-readable storage medium carrying one or more sequences of one or more instructions which, when executed by one or more processors, cause, at least in part, an apparatus to perform determining a plurality of layers of information about a specific download of particular content to the apparatus. The information in the plurality of layers is different from an amount of the particular content. The apparatus is also caused to cause the particular content to be stored progressively into a memory on the apparatus. The apparatus is also caused to perform causing a first layer of information to be presented on the local device upon a start of the specific download. The apparatus is also caused to determine an amount of the particular content stored into the memory. The apparatus is further caused to perform causing a different second layer of information to be presented progressively on the local device during the specific download based on the amount of the particular content stored into the memory.

According to another embodiment, an apparatus comprises means for determining a plurality of layers of information about a specific download of particular content to the apparatus. The information in the plurality of layers is different from an amount of the particular content. The apparatus also comprises means for causing the particular content to be stored progressively into a memory on the apparatus. The apparatus also comprises means for causing a first layer of information to be presented on the apparatus upon a start of the specific download. The apparatus also comprises means for determining an amount of the particular content stored into the memory. The apparatus further comprises means for causing a different second layer of information to be presented progressively on the apparatus during the specific download based on the amount of the particular content stored into the memory.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of presenting content download progress using multiple information layers peculiar to the download, according to one embodiment;

FIG. 2 is a flowchart of a process for presenting content download progress using multiple information layers peculiar to the download, according to one embodiment;

FIGS. 3A-3C are diagrams of user interfaces utilized in the processes of FIG. 2, according to various embodiments;

FIG. 4A is a diagram of the components of a content object that presents content download progress using multiple information layers peculiar to the download, according to one embodiment;

FIG. 4B is a diagram of the components of a service that uses the content object of FIG. 4A, according to one embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program are disclosed for presenting content download progress using multiple information layers. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, content or media includes, for example, digital sound, songs, digital images, digital games, digital maps, point of interest information, digital videos, such as music videos, news clips and theatrical videos, advertisements, electronic books, presentations, program files or objects, any other digital media or content, or any combination thereof. The terms presenting and rendering each indicate any method for presenting the content to a human user, including playing music through speakers, displaying images on a screen or in a projection or on tangible media such as photographic or plain paper, showing videos on a suitable display device with sound, graphing game or map data, or any other term of art for presentation, or any combination thereof. In many illustrated embodiments, a player is an example of a rendering module. A playlist is information about content rendered on one or more players in response to input by a user, and is associated with that user. A play history is information about the time sequence of content rendered on one or more players in response to input by a user, and is associated with that user. A download is a process of moving content from a remote device on a network to a local device across one or more communication links.

As used herein, a content object, also called a content widget, is a software object that can be embedded in a web page or email or other message for presentation to one or more users for indentifying, sharing, downloading or rendering content, or some combination thereof. Software objects are self-contained collections of data and methods and used, for example, in object-oriented programming (OOP). In some embodiments, a content object provides a graphical user interface (GUI).

Although several embodiments of the invention are discussed with respect to music download using a web browser containing one or more embedded content objects, it is recognized by one of ordinary skill in the art that the embodiments of the inventions have applicability to any type of content downloading and rendering, e.g., music or video playback or streaming, games playing, image or map displaying, radio or television content broadcasting or streaming, involving any device, e.g., wired and wireless local device or both local and remote wired or wireless devices, capable of rendering content, or capable of communication with such a device, using any application that allows objects to be embedded, such a standard web browser, a standard email client, a standard instant messaging client, and a standard file transfer protocol (FTP) client. An example well known music rendering device is a Moving Picture Experts Group (MPEG)-1 Audio Layer 3 player (MP3) player.

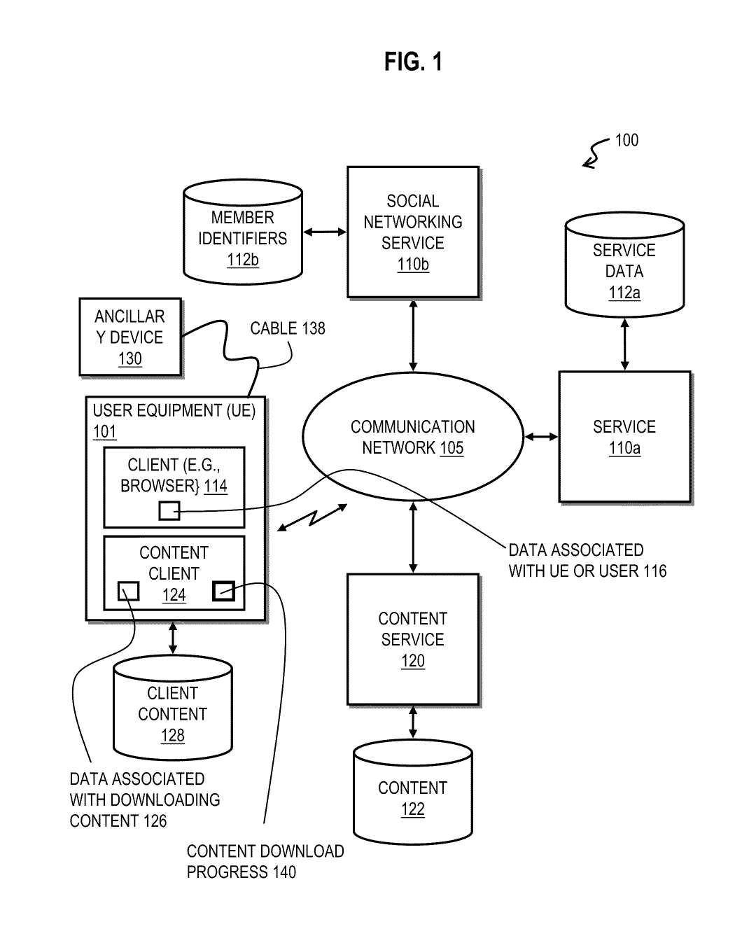

FIG. 1 is a diagram of a system 100 capable of presenting content download progress using multiple information layers peculiar to the download, according to one embodiment. When a user chooses to download content, there is often an element of excitement and anticipation. Yet, while downloading content to his or her local device, such as a cell phone or personal digital assistant (PDA) or music player, a user often has to wait with no information about the content or context of the download except for the amount so far downloaded and sometimes the total amount to be downloaded. Such information about the amount is readily digested in a few seconds, leaving the user still hungry for more information about the content or context of the download itself, such as how many minutes of music or video is being downloaded, how much of the storage capacity of the user's device will be left after the download, name or history of the artist or the work, related art such as album cover art and inside jacket art, lyrics, other artists performing similar work, and related news or concerts or advertisements, among others not listed here.

To address this problem, a system 100 of FIG. 1 introduces the capability for improving the user experience by presenting content download progress using multiple information layers peculiar to the download. Information about the content is available from a remote service through which the content was identified, such as a social networking service that allows content sharing, or the content service itself, and is usually cached in some form on the user's own device, e.g., in a data structure. Information about the context of the download, such as the user equipment capacity, the user, and friends of the user, is available on the user's own device, called user equipment (UE) herein. A module on the user equipment monitors the download and presents layers of information about the content or context to the user as the content downloads, providing the user with information of interest which is at least distracting, and even entertaining, for the user during the download. For example, a grayscale image of visual artwork associated with the content is presented at the start of the download and progressively fills with color as the download progresses. This engages the user with the gradual reveal of information very likely to be of interest to the user because it is related to the content the user has just requested to download and is likely excited about. Because the information presented is related to the user or the content, the information is highly likely to be much more interesting to the user than a mere generic progress bar depicting the amount of information downloaded. Thus an advantage of some embodiments of the invention is that a user experience is improved by engaging the user with information that is more likely to be more exciting or interesting to the user than a progress bar. A content download progress module is a means to provide this advantage.

As shown in FIG. 1, the system 100 comprises the local device, such as a user equipment (UE) 101, having connectivity to service 110a or social networking service 110b (collectively referenced hereinafter as service 110) or content service 120, or some combination, via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, Internet protocol (IP) data cast network, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, radio/television broadcast receiver, electronic book, video projector, game device, or any combination thereof. It is also contemplated that the UE 101 can support any type of interface to the user (such as “wearable” circuitry, etc.). In some embodiments, the UE 101 is connected to a local ancillary device 130, such as a cell phone or MP3 player or video player, via a local one-to-one connection, e.g., using an infrared link or a short range wireless (e.g., Bluetooth) link or a cable 138 as depicted.

A content client process 124 on the UE 101 downloads content from content service 120 and, in some embodiments, also renders that content locally or sends the content to an ancillary device 130. According to various embodiments, a content download progress module 140 on the UE 101 indicates download progress to a user of UE 101 using multiple layers of information peculiar to a specific download of particular content. In the illustrated embodiment, the content download progress module 140 is part of the content client 124, as depicted in FIG. 1. In other embodiments the module 140 is part of another module of UE 101, such as a client process 114 or an operating system for UE 101.

By way of example, the UE 101, and one or more hosts for service 110 and content service 120 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 4) header, an internetwork (layer 3) header and a transport (layer 4) header, and various application headers (layer 5, layer 6 and layer 7) as defined by the OSI Reference Model.

According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages. In some embodiments, either or both the client 114 or the content client 124 is a browser presenting a web page provided by service 110 or 120, respectively.

The service 110a stores information related to the service 110a in a service data structure 112a, such as a database. For example, in some embodiments, the service 110a is a content store service through which a user can identify or purchases content. The service 110a keeps track of content available, a subscriber to the service, and subscriber billing information by storing information about content and subscribers in the service data structure 112a. The social networking service 110b provides social networking among members called subscribers and stores information related to the service 110b in a service data structure 112b, such as a database. For example, in some embodiments, the social networking service 110b keeps track of subscriber profiles and lists of a subscriber's contacts (e.g., friends) by storing user profile data in the member identifiers data structure 112b. Similarly, the content service 120 stores information related to the content in a content data structure 122, such as a database. For example, in some embodiments, the content service 120 stores content and metadata about the content in the content data structure 122.

When the clients 114 and 124 on UE 101 interact with services 110 and 120, data is received in one or more messages, e.g., in one or more HTTP messages carrying web pages that are presented to a user on a display of UE 101. This information is cached locally, at least in fields associated with the web page, e.g., in data structure 126 holding data associated with downloading content, and in data structure 116 associated with the UE 101 or a user of UE 101,or both. When content is downloaded to the UE 101 it is stored in client content data structure 128, such as a database, or in a data structure, not shown, on ancillary device 130, or both.

According to various embodiments, the content download progress module 140 obtains from data structures 116, 126 or 128, or some combination, information peculiar to a specific download of particular content. The data structures 116, 126 and 128 are means for storing information locally about a specific download or particular content that is likely to be of interest to a user downloading content to UE 101. Because this information is local, it is readily presented on UE 101 while content is being downloaded to UE 101 at the same time. In some embodiments, the relevant information is small enough that it can also be downloaded quickly during, simultaneously and/or synchronously to one of these local caches in intervening data packets while the content is being downloaded to the UE 101. Once local, the information is readily revealed as one layer of information about the specific download of the particular content. An advantage of using locally cached information that is small in size relative to the content being downloaded is that such information is readily obtained in time to present before the download is complete.

Although modules, process and data structures are shown as integral components arranged on certain network nodes in a particular order for purposes of illustration, in other embodiments, one or more modules, processes or data structures, or potions thereof, are arranged in a different way on the same or different one or more nodes connected to network 105. For example, in some embodiments, some UE information depicted in data structure 116 is in a separate data structure (not shown) maintained by an operating system or other application on UE 101, and is outside the data cached in data structure 116 for client 114. By way of example, the content client 124 includes one or more components for presenting content download progress using multiple information layers peculiar to the download. It is contemplated that the functions of these components may be combined in one or more components or performed by other components of equivalent functionality, such as one or more components of an operating system or content object received in client 114.

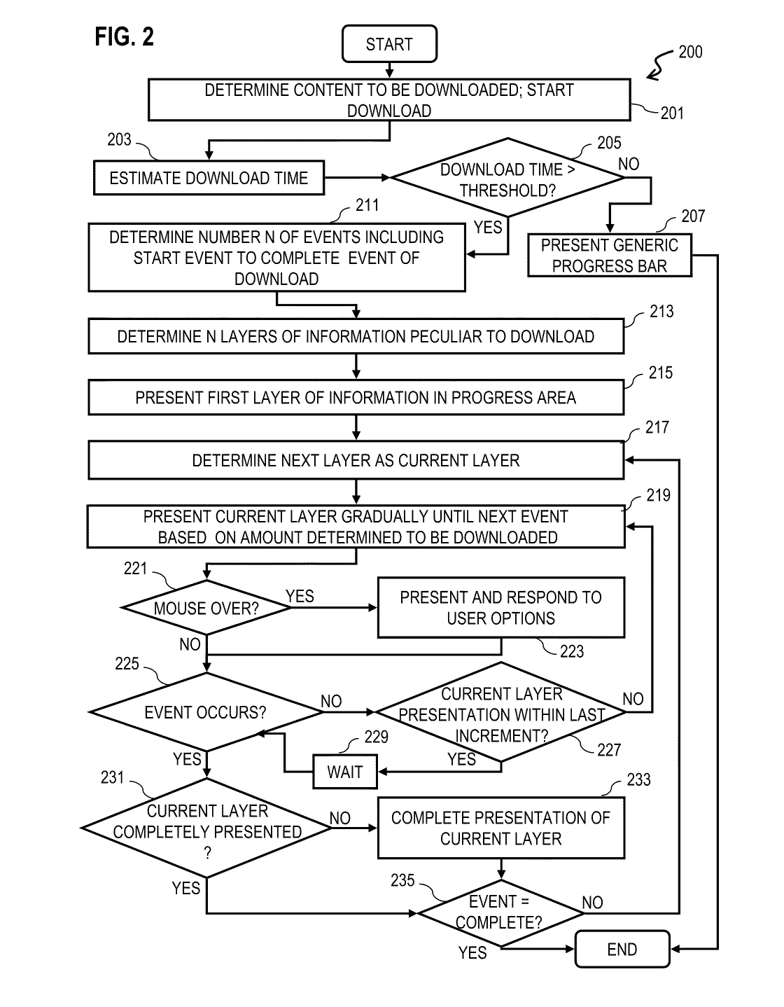

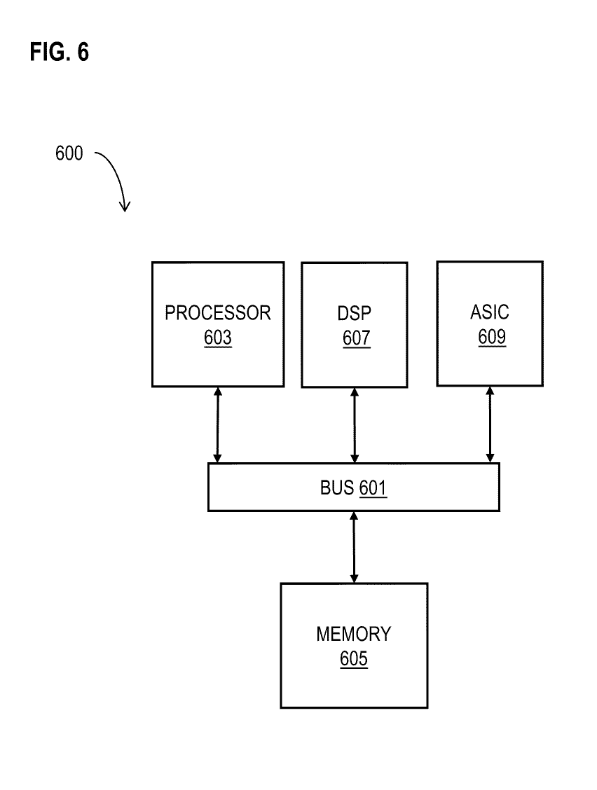

FIG. 2 is a flowchart of a process 200 for presenting content download progress using multiple information layers peculiar to the download, according to one embodiment. In one embodiment, the content download progress module 140 performs the process 200 and is implemented in, for instance, a chip set including a processor and a memory as shown FIG. 6. Although steps are depicted in FIG. 2 in a particular order for purposes of illustration, in other embodiments one or more steps or portions thereof are performed in a different order or overlapping in time, in series or parallel, or one or more steps are omitted or one or more other steps are added, or the process is changed in some combination of ways.

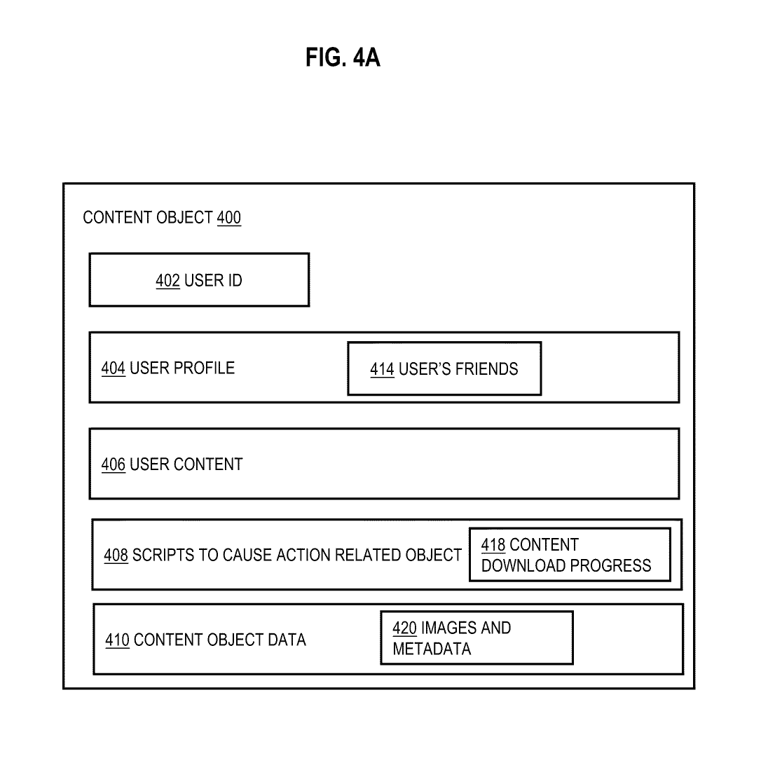

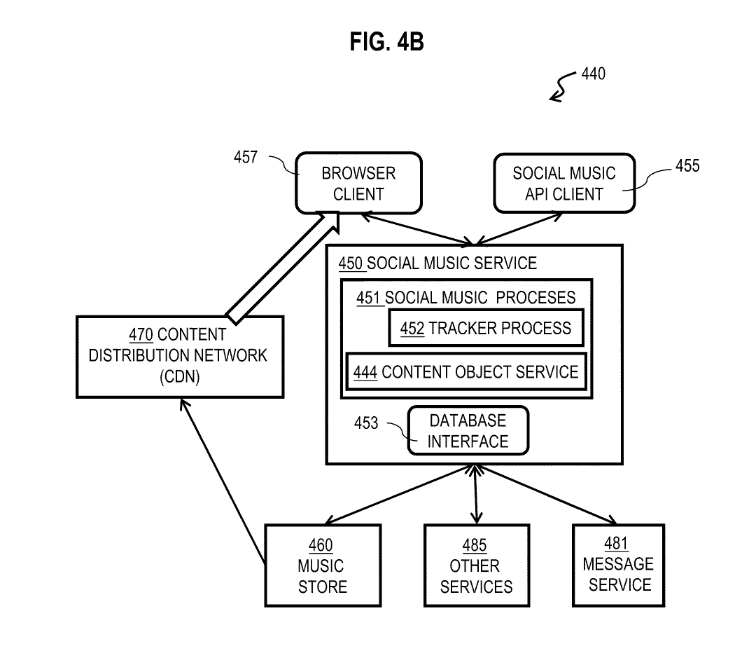

In step 201, the particular content to be downloaded is determined. For example, the particular content is identified in a web page received from a content store, e.g., service 110a, with a link to the content service 120 used to retrieve the content. Any method may be used to indicate the link, which is a network location of the content, such as a uniform resource locator (URL) text string that is resolved by a URL name server in network 105. In general, the web page may include a name of the content and some metadata about the content, along with a thumbnail or full image of related artwork, such as an album cover for a song track or album, or a poster for a movie, or links thereto. As another example, the particular content is identified in a message or social networking web page of a friend received from a social networking service, e.g., service 110b, with a link to a music store service 110a or content service 120 used to retrieve the content. The web page may include a name of the friend and some comments by the friend about the content, along with other profile information about the friend, or links thereto. As another example, the particular content is identified in a content object embedded in an email or text message received from a friend or contact, with a link to the content service 120 or store 110a used to retrieve the content. The content object may include a name of the content and some metadata about the content, along with a thumbnail or full image of related artwork, as described in more detail below with reference to FIGS. 4A and 4B. In some embodiments step 201 includes causing the particular content to be stored progressively into a memory on the user equipment, e.g, UE 101.

In step 203, the time to download the content is estimated, e.g., based on a download bandwidth on the communications link between the UE 101 and the network 105 and a size of the content. The download bandwidth is often detected by the UE and cached in data structure associated with the UE, e.g., data structure 116, or in a different data structure of the operating system. The size of the content is often available when the link is followed to the content server and cached in the data structure 126 associated with the downloading content. The size divided by the bandwidth corrected by a factor for the message and communication link overhead gives the estimated download time, as is well known in the art. In step 205, it is determined if the download time is greater than a threshold time. The threshold time is selected as a few seconds, e.g., about 5 seconds. If the estimated download time is less than the threshold time, then the wait by the user is short enough that more interesting information than a progress bar is not likely to be used. In this case, a generic progress bar is presented in step 207, and the process ends. An advantage of such testing is to conserve resources and speed up the download progress presentation with a generic progress bar in circumstances where the user experience is not poor. The threshold testing is a means to obtain this advantage. In some embodiments, generic progress bars are never used; and step 203 and step 205 and step 207 are omitted.

If it is determined in step 205, that the estimated download time is greater than the threshold time, then in step 214 and following steps, progress is presented using multiple layers of information that is peculiar to the specific download of the particular content, so that a user is satisfactorily engaged during the download.

In step 214 a number N of events to indicate from start to completion of the download is determined. In some embodiments, only the start and completion of the download is to be indicated and N=2. In some embodiments other interim events are to be indicated to a user, such as when each track of an album is downloaded, or when a sufficient portion of the content has been downloaded to start rendering the content on the UE, or to start side loading content to the ancillary device 130. In some embodiments, the content is transcoded before side loading, i.e., translated from one codec to another, such as converting sound from one codec to MP3 for rendering by an MP3 player as ancillary device 130. In such embodiments, an event to indicate is the actual start of transcoding, or a sufficient portion of the content downloaded to start transcoding. In other embodiments other events are indicated. Thus, the event is one of a group of events comprising: a start of download, completed download of a separate portion of the particular content (e.g., one track of a music album or one short story in an anthology of short stories), a receipt of a sufficient portion of the particular content to begin rendering the particular content; a start of side loading at least a portion of the particular content to a local ancillary device; a start of transcoding the particular content to a format for rendering on the ancillary device; a delivery of a sufficient portion of transcoded particular content to begin rendering the transcoded particular content on the ancillary device; an end of transcoding; and an end of side loading, and completion of the download of all of the particular content, among others. An advantage of allowing more than two events to be indicated is that the presentation is more informative for the user. Step 214 is a means for allowing more than two events to be indicated. For purposes of illustration, it is assumed that N=3 for three events: (1) the start of download; (2) sufficient portion of the content has been downloaded to start rendering the content on the UE; and (3) completion of the download for all of the particular content.

In step 213, N layers of information peculiar to the specific download of the particular content are determined. At least one layer of information in the plurality of layers is different from an amount of the particular content. Information about the specific download comprises one or more of: content information about the particular content; and context information about the local device or a particular user of the local device. The plurality of layers of information about the specific download are obtained from at least one of a remote service, e.g., in a current webpage or in response to a request, such as a request for metadata about the content, or a web search on the name of the particular content or artist, or a previous message from a remote service, or a search on friends in social networking service 110 that have the specific download and what their comments are on it, e.g., cached in data structure 116 or data structure 126, or the particular content, e.g., in data structure 128, or a local device e.g., in data structure 116, or a local ancillary device, e.g., in a data structure on device 130.

In some embodiments, the N layers include context information about user, user equipment, source of the link, or content information or metadata about the content itself, such as interesting facts about a song or album being downloaded. Any non-size information may be included, such as related facts, advertisements, maps showing location information such as studio location where recorded or birthplace of artist, and cost of download at a particular source. For example, a text string stating “Did you know that Artist was born on a cruise ship,” is one layer of information and a different layer of information showing an image of the Artist or cruise ship or a map of the Artist's birth location. In some embodiments, order for the layers of information is determined by the value of a parameter associated with the layer of information, e.g., the amount of information in the layer or the date the information in the layer was last updated, with increasing values in later presented layers.

In some embodiments with many layers of information, all the information is clustered, sorted by relevance to the particular content or the user of UE 101, or both, and then divided into N groups. Any relevance engine may be used to determine relevance, as is well known in the art. In some embodiments, N layers of information are selected by relevance or at random from a larger number of layers of information.

In some embodiments with few layers of information, the information is broken up into N layers, e.g., by breaking a single color image into separate intensity, red, green and blue images; or by breaking one sentence of text up into N words or clauses.

For example, when N=3 and the only non-size information is a single image, such as an album cover image, the first layer of information for the specific download of the particular content is an intensity (grayscale) image of artwork associated with the content, the second layer of information is the blue content of the image added to the intensity image, and the third layer of information is the full color and intensity of the image. In some embodiments, the first layer is an image of the friend who provided the link to the content, the second layer is the grayscale image of the artwork and the third level is the full color image of the artwork. In an example embodiment, the first layer is textual information, and the second layer is a grayscale image of the associated artwork, and the third layer is a full color image of the associated artwork. In general, any layer can present or include any information, content media or data. An advantage of N layers of information is to keep the user interested as the user is informed of the progress of multiple different events during the download. Step 213 is a means to achieve this advantage.

Thus, in step 214, a plurality of layers of information is determined about a specific download of particular content to a local device. The information in the plurality of layers is different from an amount of the particular content.

In step 215 a first layer of information is presented in a progress area of a display associated with the user equipment. For example, textual information about the source or content is presented in the progress area. Thus, a first layer of information is caused to be presented on the local device upon a start of the specific download.

In step 217, the next layer of information to be presented is determined to be the current layer, e.g., the grayscale image of the associated artwork is made the current layer of information.

In step 219, the current layer of information is presented gradually in the time interval to the next event. If the next event is completion of the download, then another percentage of the current layer is presented as each corresponding percentage of the download is accomplished. If the next event is downloading a sufficient portion to begin rendering locally, then another percentage of the current layer is presented as each corresponding percentage of the portion to enable rendering is downloaded. In some embodiments, the interim progress toward an event is not measured or is not measurable, and the portion of the current layer presented is based on an estimated time to the next event and the actual elapsed time. Thus if one minute is estimated to download a large enough portion to begin rendering locally, then another 10% of the current layer is presented every 6 seconds. In some of these embodiments, the current layer is not completely presented until the event actually occurs, e.g., the last 10% is not presented until a sufficient portion to allow rendering to begin is actually received. Thus, in some embodiments, step 219 includes determining an amount of the particular content stored into the memory, including any amount estimated to be stored in memory. The amount of the current layer presented during step 219 is based, at least in part, on the amount of the particular content determined to be stored into the memory.

Thus, a different second layer of information is caused to be presented progressively on the local device during the specific download, which second layer of information is completely presented shortly after, at, or before completion of the specific download. An advantage of progressive presentation is to give the user a natural indication of when the next event will be reached, as the user intuitively projects the progress of the current layer of information to the edge of the presentation area. Step 219 is a means to provide this advantage.

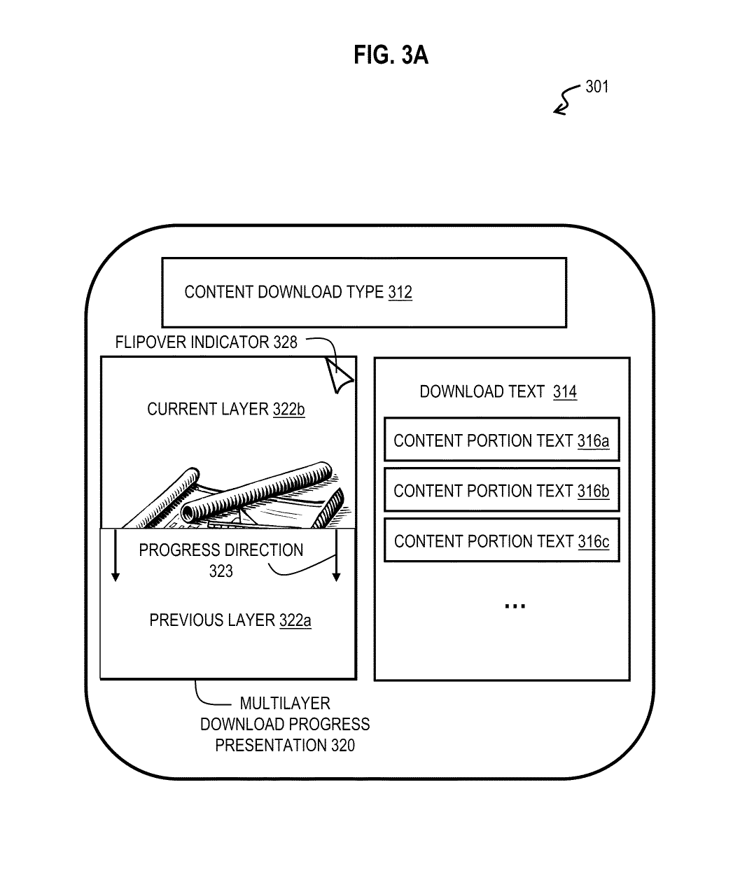

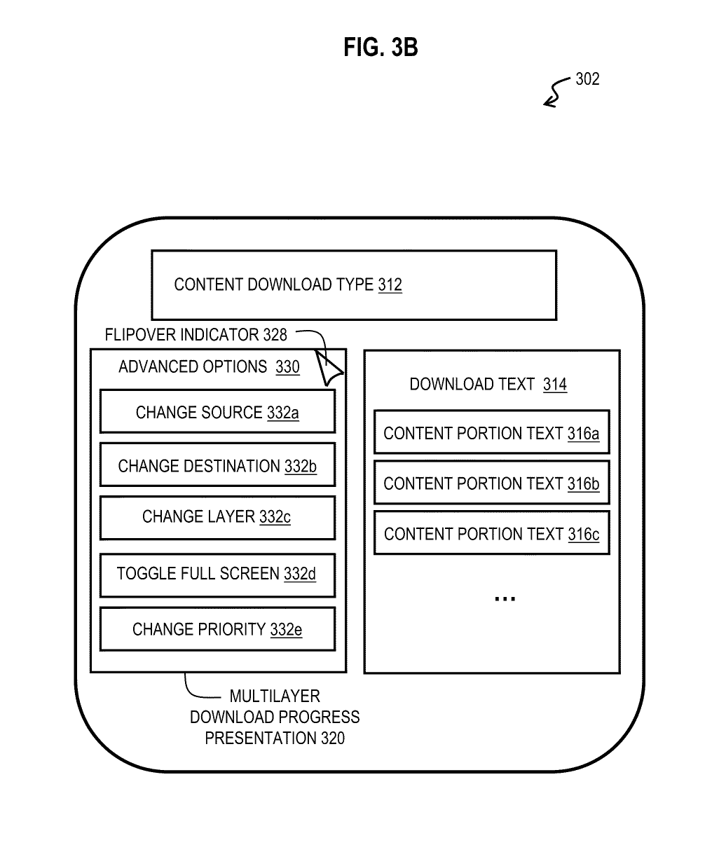

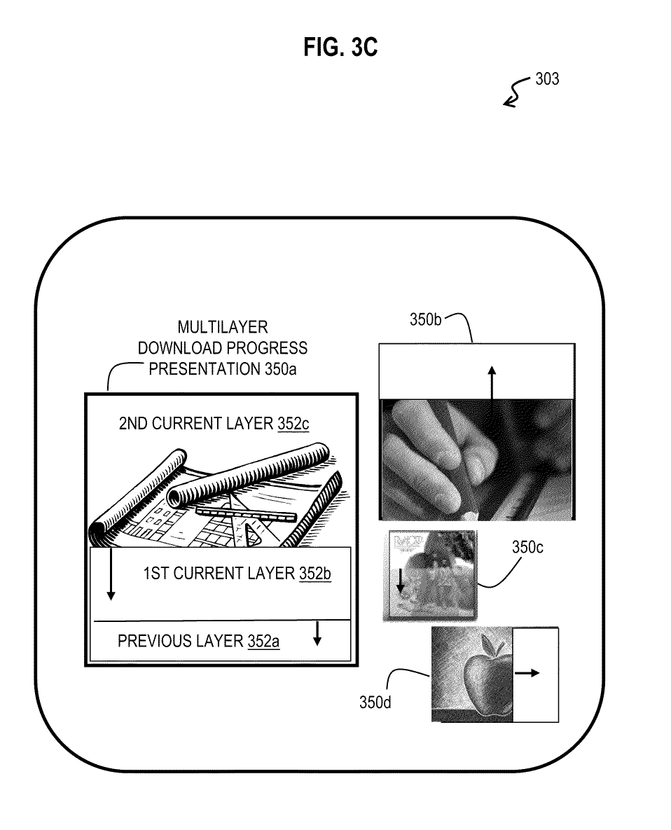

FIGS. 3A-3C are diagrams of user interfaces utilized in the processes of FIG. 2, according to various embodiments. FIG. 3A depicts a graphical user interface (GUI) 301 on a display screen of UE 101. The GUI 301 includes a content download type area 312, a download text area 314 and a multilayer download progress presentation area 320. The content download type area 312 presents data that indicates the content type (e.g., file, document, audio, video, game, etc.) being downloaded. The download text area 314 presents generic text related to the download, such as in prior art approaches, e.g., a file name and file size and percent of file downloaded and perhaps time to complete download. In some embodiments, there is a separate text area for each portion of the download, e.g., for each track of a music album being downloaded, such as content portion text 316a for a first portion of the download, a content portion text 316b for a second portion of the download, a content portion text 316c for a third portion of the download, among others indicated by ellipsis. Although areas and images are shown in FIGS. 3A-3C as integral regions of a display in a particular order for purposes of illustration, in other embodiments one or more areas or images, or portions thereof, are arranged in a different order or omitted or other areas are added, or some combination of changes is made.

The multilayer download progress presentation area 320, includes a previous layer portion 322a in which is presented information of one layer (e.g., the first layer), and a current layer portion 322b which is being presented progressively over the previous layer portion 322a, with direction of progress 323 indicated by the solid fill arrows. For example, a grayscale image in a current layer 322b is gradually presented over text in the previous layer area 322a. This presentation provides the advantage of being both interesting and informative; and the GUI 301 is a means for achieving this advantage. The current layer portion 322b is presented progressively over the previous layer portion 322a during step 219 of FIG. 2.

In some embodiments, the multilayer download progress presentation area 320 includes a flipover indicator 328 that indicates where a pointing device (such as a mouse) can be positioned and activated, or touchscreen touched, to provide presentation options; as if those options appeared on the other side (flipside) of a virtual piece of paper on which the progress is presented. The options that appear on the flipside are described in more detail below with reference to FIG. 3B.

Returning to FIG. 2, in step 221, it is determined whether there is a pointing device (e.g., a mouse) positioned over an active area of the multilayer download progress presentation area 320. If so, then in step 223 user options are presented and user input received in response is used to cause the process to perform associated functions, as described in more detail below with reference to FIG. 3B. For example, if a pointing device is positioned over the flipover indicator area 328 and activated, the user is presented with options for what and how information is presented in the presentation area 320 or what and how the download proceeds, or both, as described in more detail below. For example, the user can control side loading at least a portion of the particular content to a local ancillary device in step 223 before completion of the specific download. In some embodiments, the user can also control transcoding the particular content to a format for rendering on the ancillary device and sending the transcoded particular content to the local ancillary device in step 223. An advantage of giving the user more control over the download before completion is to speed the utility of the download so that when the download is complete the user can immediately use the particular content as desired, e.g., on ancillary device 130. Of course, an advantage of allowing the user to change the presentation of progress is to make the presentation more interesting to the user. Step 223 is a means for achieving both advantages.

In step 225, it is determined whether the next of the N events has occurred, e.g., the download is complete or a large enough portion is downloaded to begin rendering at least a portion of the particular content. If not, then in step 227 it is determined whether the presentation of the current layer is within a last progressive increment. If not, then the next increment can be presented in step 219, thus gradually presenting the current layer. If so, then no more of the current layer is presented; the process waits and then again determines whether the expected next event occurs in step 225. An advantage of not completing the presentation before the event occurs is to avoid misinforming the user about completion of the current stage of progress. Step 225, step 227 and step 229 are means for providing this advantage.

If it is determined, in step 225, that the next event has occurred, then in step 231 it is determined whether the current layer is completely presented. If not, then in step 233 the current layer is presented completely. This advantageously signals to the user that this stage of the download is complete. Step 231 and step 233 are means to provide this advantage.

In some embodiments, step 225 includes performing some function associated with the event. For example, in some embodiments, step 225 includes beginning to render the portion of the particular content that is downloading. In some embodiments, step 225 includes side loading at least a portion of the particular content to a local ancillary device before completion of the specific download. In some embodiments, step 225 includes transcoding the particular content to a format for rendering on the ancillary device and sending the transcoded particular content to the local ancillary device. In some embodiments, these functions are performed automatically. In some embodiments, these functions are performed based on user input received in step 223.

In step 235, it is determined whether the event that just occurred is the completion of the download. If so, then the process ends. Otherwise control passes back to step 217 to determine the next layer of information associated with the next event as the current layer of information to present, as described above. Thus, a different third layer of information is caused to be presented progressively during the specific download. The third layer of information is completely presented at or before completion of the specific download and is presented progressively during a time interval different from a time interval during which the second layer of information is presented progressively. In this embodiment, the time intervals are separated by an event, e.g., sufficient portion to begin rendering, other than start of the specific download and completion of the specific download.

In some embodiments, progress toward one event begins before progress toward another event ends. For example, transcoding can begin before there is sufficient content downloaded to start rendering the content. Therefore, in some embodiments, the time intervals overlap. That is, a second current layer is begun to be progressively presented before the first current layer is completely presented.

FIG. 3B depicts a graphical user interface (GUI) 302 on a display screen of a UE 101 after the user has selected the flipover indicator 328 according to another embodiment. The GUI 302 includes the content download type area 312 and the download text area 314, as described above. In GUI 302, however, the multilayer download progress presentation area 320 displays advanced options area 330 instead of one or more information layers for the specific download. GUI 302 is a means for achieving the advantage of giving the user more control over the download process and the presentation of its progress. As described above, multilayer download progress presentation area 320 includes the flipover indicator 328. In GUI 302, the flipover indicator 328 is activated (e.g., by a pointing device such as a mouse or by touching a touchscreen) to return to the progressive presentation of information layers for the specific download depicted in FIG. 3A.

In the illustrated embodiment, the advanced options area 330 includes a change source area 332a, a change destination area 332b, a change layer area 332c, a toggle full screen area 332d and a change priority area 332e. In other embodiments more or fewer areas are presented.

The change source area 332a is selected by a user to change the source of the download. Often, there is more than one server from which particular content can be downloaded and the servers are distributed globally. Network conditions between the user and one server may be congested, or the server heavily utilized, so that the download is very slow and better performance is likely from anther server. Using change source area 332a, the user can select another source of the download. Any method known in the art may be used to allow the user to change the source, for example using a pull down menu of available sources for the same content.

The change destination area 332b is selected by a user to change the location where the content is stored locally. For example, the content can be stored locally in client content database 128 or as a file in another directory or on ancillary device 130. Using change source area 332b, the user can select another destination for the particular content. Any method known in the art may be used to allow the user to change the local destination for the particular content, for example using a browse button and pull down menu of available devices and directories.

The change layer area 332c is selected by a user to change the layer of information to be presented as the current or subsequent layer of information. As stated above, in some embodiments, there are only N layers of information all of which are to be presented. In such embodiments the user can change the order of the presentation, e.g., first the full color and then the grayscale. In some embodiments, there are more than N layers of information from which N layers were selected automatically, either by relevance or at random. In such embodiments, the user can change not only the order of the presentation, but also the layers to be presented. For example, the user can change the measure used for relevance, the type of information whether content information or context information, e.g., preferring context information about the friend who recommended the content, and the actual layers of information available of that particular type. Any method known in the art may be used to allow the user to select the layer of information, for example using a pull down menu of available layers of information. In some embodiments, the user is also allowed to input or change a direction of progress of a later layer of information over the earlier layer of information, e.g., by selecting uniform or random directions of progress.

The toggle full screen area 332d is selected by a user to change the size of the multilayer download progress presentation area 320. In some embodiments, the user can select from a range of sizes, e.g., using a pull down menu. In some embodiments, selecting the toggle full screen area 332d cause a presentation area 320 that is in a limited region of GUI 301 to fill a major region or all of the display area for GUI 301, or back.

The change priority area 332e is selected by a user to change the importance of the specific download compared to other downloads that might also be occurring. For example, a user may start a download for a first music album then during the download discover an even more interesting album or video and begin to download that. The UE 101 usually divides the available bandwidth on the communication link to the network 105 automatically between the two download, e.g., either evenly or giving higher priority to the first or the smallest download. Using change priority area 332d, the user can select another priority for the specific download associated with the presentation area 320. Any method known in the art may be used to allow the user to change the priority, for example using a pull down menu of priorities (e.g., textual values high, medium, low, or numeric values 1 to 10, with 1 being the first priority). In some embodiments, the size of the presentation area 320 is proportional to the priority, with the highest priority download having the largest presentation area, whether full screen or not.

The advanced option selected is detected in step 223 and implemented in step 223 or step 225. Thus, before the completion of the specific download, user input for configuring the presentations is determined and the different second layer of information is caused to be presented progressively based on the user input. The advantage of giving the user control over the download or its presentation is to improve the user experience; and advanced options area 330 is a means to achieve this advantage.

FIG. 3C depicts a graphical user interface (GUI) 303 on a display screen of UE 101 after the user has selected the toggle full screen area 332d, according to another embodiment. Because of the selection of a full screen, the GUI 303 excludes the content download type area 312 and the download text area 314 of GUI 301. Instead, the GUI shows only the presentation area for one or more downloads in progress at the UE 101. For purposes of illustration, it is assumed that UE 101 is downloading four different contents of different priorities set by the user; and progress is presented in a corresponding four multilayer download progress presentation areas depicted as presentation area 350a, presentation area 350b, presentation area 350c and presentation area 350d, respectively.

The highest priority is for the download associated with presentation area 350a, so that area is the largest. The size of the presentation area decreases for presentation area 350b, presentation area 350d and presentation area 350c with diminishing priority downloads, respectively. An advantage of different sizes for different priority downloads is to increase the information content of the GUI 303, and therefore to increase the interest for the user. The variable sized presentation areas 350 of GUI 303 is a means to provide this advantage.

In the illustrated embodiment, presentation area 350a presents not only the previous layer of information in previous layer area 352a, but also two different progressively presented current layers of information. A first current layer of information is presented in a first current layer area 352b and a second layer of information in a second current layer area 352c, illustrating overlapping time intervals for progressively presenting different layers of information associated with different events. For example, the first current layer area 352b is associated with downloading enough of the particular content to start transcoding and the second current layer area 352c is associated with downloading enough of the particular content to start rendering on the ancillary device. An advantage of multiple current layer areas where information is progressively presented for one download is to increase the information content of the presentation area 350a, and therefore to increase the interest for the user. The multiple current layer areas of presentation area 350a are means to provide this advantage.

Also illustrated in FIG. 3C is that the direction of progress need not be fixed. In various embodiments the directions of progress are down, up, left to right, right to left, diagonal in any of four directions, from the middle outward and form the outer edges inward. In some embodiments, the direction of progress is automatically selected, e.g., at random. In some embodiments, the user selects the direction of progress when the user selects the change layer area 332c, described above. An advantage of different directions of progress is to increase the visual complexity and therefore visual interest for the user. The GUI 303 is a means to provide this advantage.

Also illustrated in FIG. 3C is multiple layers of information for a single image associated with the download in presentation area 350c. The previous layer area presents a grayscale version of cover art for a music album, while the current layer area presents a full color version of the same cover art.

FIG. 4A is a diagram of the components of a content object 400 that presents content download progress using multiple information layers peculiar to the download, according to one embodiment. By way of example, the content object 400 includes one or more components for presenting content from a service 110 and customizing the interaction behavior of the content object 400 based on, for instance, the availability of content presented by the content object 400. It is contemplated that the functions of these components may be combined in one or more components, such as an operating system or content client 124 or performed by other components of equivalent functionality. In one embodiment, the content object 400 includes, for example: (1) a user ID field 402; (2) a user profile field 404; (3) a user content field 406; (4) script field 408 holding or pointing to scripts to be executed by a client process in order to cause actions related to interacting with the content object 400; (5) content object field 410; or a combination thereof.

The user ID field 402 holds data that indicates, for example, a user registered with the service 110 associated with the content object 400. Any user ID may be used, such as a node identifier for the device used for rendering the content, a user supplied name, an email address, or an ID assigned to a user who registers with the service 110. In some embodiments, a user ID is inferred from a node identifier for the device used for rendering the content included in a lower protocol header. In some embodiments, the user ID field 402 is omitted. In some embodiments, a user is authenticated and authorized to access the service 110 in a separate login process, not shown, but well known in the art.

The user profile field 404 comprises data that indicates the user profile of the owner of the content object 400 (called owner hereinafter), such as one or more of any of the following: an index for the owner into the member identifiers database 112b; the owner's authorization or login credentials (such as password for accessing the user's home page); a pointer to the content in the service 110; one or more home pages for the owner on corresponding social networks, contact lists; and/or other external services 110; the owner's contact information such as email address, an image of the owner, a theme song of the user, a visual theme of the owner, or an avatar of the owner. The example user profile field 404 includes the owner's friends field 414 that holds data that indicates one or more user IDs of other members associated with the owner in the one or more social networks and/or contact lists.

The user content field 406 holds data that indicates the content identifiers (content IDs) for one or more content items (e.g., music track, video, etc.) associated with the owner in the corresponding service 110 (e.g., music play history, such as values for song name and artist name in a music service). In the approach described herein, the availability of content in the user content field 406 and content object data field 410 dictates the interaction behavior (e.g., available functions, alerts, messages, etc.) provided by the content object 400.

The script field 408 holds data for one or more scripts that indicates one or more processes and/or actions to be performed by the content object 400, such as a process to present the content object 400 to a user and a process to respond to user input associated with the content object 400, such as activating an action presented by the content object 400, e.g., playing the owner's theme song, playing the owner's current song, playing short segments (denoted as “snippets”) of all the content in the playlist, playing the owner's top ten list, buying currently/previously playing content, requesting more information about some content, and/or sending messages or otherwise contacting the owner of the content object. In one embodiment, the script field 408 also holds data for one or more scripts to initiate processes for determining the availability of content provided by the content object 400, determining the interaction behavior of the content object 400 based on the availability of the content, determining the capabilities (e.g., input/output capabilities) of a device requesting access to an embedded content object, and mapping controls of the content object 400 based on the determined capabilities. As is well known in the art, scripts are instructions that cause a web browser or other like application to perform one or more functions. For example, script in the JAVA™ programming language, called a JAVA applet, causes a web browser with a Java engine to perform the steps indicated in the script, as is well known in the art. In other embodiments, the script field 408 may include information or data to support implementation with other methods including scripting or script-like functions such as Adobe Flash (ActionScript), AJAX, Web Runtime (WRT), and the like.

According to some embodiments, the script field 408 includes content download progress field 418 which holds data that indicates instructions for performing the functions of the content download progress module 140. These instructions allow a receiving process to perform one or mores steps of process 200, described above with reference to FIG. 2.

The content object data field 410 holds other data used by the content object 400, such as an image (icon) and/or avatar to represent the content object 400 on a display device, type or form of the content object 400 (e.g., a circle, bubble, star form, rectangle, cube, polyhedron) and/or other related information (e.g., degree of similarity between the viewer and the owner; the percentage of the locket owner's playlist or play history, or both, that falls into each of multiple categories; etc.).

FIG. 4B is a diagram of the components of a service that uses the content object of FIG. 4A, according to one embodiment. In the illustrated embodiment, the service 110 is a social music service 450 and supports users in finding and playing music on their local devices (e.g., UEs 101) over the communication network 105. The social music service 450 includes social music processes 451 and a database interface process 453. The social music processes 451 are a set of applications (e.g., a Java™ stack written in the Java™ programming language that can be installed and executed on any device that includes a Java™ virtual machine (JVM) process). The social music processes 451 include instructions for finding songs played by various users and metadata about songs and using the metadata to direct users to resources on the network where the user can sample, purchase or download those songs, alone or in some combination. The database interface process 453 is the interface between the social music service 450 and the content databases (not shown) available over the communication network 105; and is used to retrieve and store user information, metadata, and event data, and to retrieve and store content.

In the illustrated embodiment, the social music processes 451 include played content tracker process 452 to track played content and to use the database interface process 453 to store and retrieve the event data that describes what is being played by whom and when. In the illustrated embodiment, the social music processes 451 include a content object service 444.

According to the approach discussed herein, a content object 400 can be created to illustrate the taste or preferences of a content services user based on that person's content rendering list (i.e., playlist) or content rendering history (i.e., play history). For example, a content object 400 is created to illustrate the musical taste of a social music service client user based on that person's play list or play history. After the content object 400 is generated in the content object service 444 of the social music service 450, the content object 400 can be emailed to other users in the particular user's social network or posted to a social network web page, such as a Facebook web page, or transferred via an instant messaging (IM) service or a web blog. Alternatively, the content object 400 can be created, e.g. by a content or service provider, to illustrate any content or media itself, and the content object 400 can be delivered and presented on a web page were user can manipulate it to initiate downloading of the content or media with related layer information.

For example, a subscriber generates a music content object 400 by interacting with the content object service 444 (directly or indirectly through a web page) in at least two ways. First, the subscriber imports his or her play history (e.g., from last.fm, from yahoo music, or from some other music service). For example, in some embodiments, the subscriber's musical profile is automatically collected from the music that the subscriber listened to with that person's mobile phone (e.g., UE 101). Secondly, the subscriber chooses one song as a theme song that best represents the subscriber's musical taste, and populates the content object with multiple other songs selected from the subscriber's play history. In many embodiments, the subscriber also uploads to the content object 400 an image to represent the subscriber's musical tastes, such as an image of the subscriber or an image associated with the theme song.

For example, the content object service 444 implements a music content object 400 that will play a musical profile of the particular subscriber as, for instance, clips of music on the particular subscriber's playlist. The music content object 400 can be embedded in various social web pages or embedded in other messages. Any user in the social network may activate the content object 400 from the social network page (presented to a user via browser 114) or other message presentation client, such as content client 124. The clips of content in the content object 400 can be played via the UE 101 or ancillary device 130. In an example embodiment, the music content object 400 has direct access to a music store 460, such as service 110a, to enable the listener to purchase the song for the clip being played. Thus a user can show off the user's favorite tunes to friends in a social network or other network application. Furthermore, a user can discover and/or purchase one or more favorite songs of a friend in the user's social network or other network application.

In one embodiment, the social music service 450 interacts with other processes on the network 105 using the hypertext transfer protocol (HTTP), often in concert with the Representational State Transfer (REST) constraints. The other processes may be on the same node or on different nodes.

In some embodiments, a user's device (e.g., UE 101) includes a service client, such as social music API client 455, to interact with the social music service 450, or a browser 457 (e.g., client 114) to interact with web pages using HTTP, or both. In some embodiments, interactions with the user can be through web pages and the user's browser 114; so that a separate service application 455 is omitted. The social music service 450 interacts with one or more music store systems 460 (e.g., 110a), such as the Nokia Ovi Music Store, to purchase songs to be downloaded to a user's device. The download is often accomplished using a Content Distribution Network (CDN) 470, such as content service 120. The music store 460 authorizes the CDN 470 to download to the client and then directs a link on the user's browser 114 to request the content from the CDN 470. The content is delivered to the user through the user's browser 114 as data formatted, for example, according to HTTP or the real-time messaging protocol (RTMP) or the real-time streaming protocol (RTSP), all well known in the art. As a result, the content is stored as local content on the user's device (e.g., client content database 128 on UE 101). The local content arrives on the UE 101 either directly from the CDN 270, or indirectly through some other device or service (not shown). During this download, the content download progress script 418 in the data object 400 is executed to serve as the content download progress module 140.

In some embodiments, the social music service 450 uses a message service 481 to receive event data about playback events on the subscriber's device. In some embodiments, the social music service 450 uses other services 485 available on the network 105 such as people services to connect with other persons in a social music group of persons, mapping services to show a subscriber's location and points of interest on a map, and gaming services to determine the subscriber's status in one or more games.

The processes described herein for presenting content download progress may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

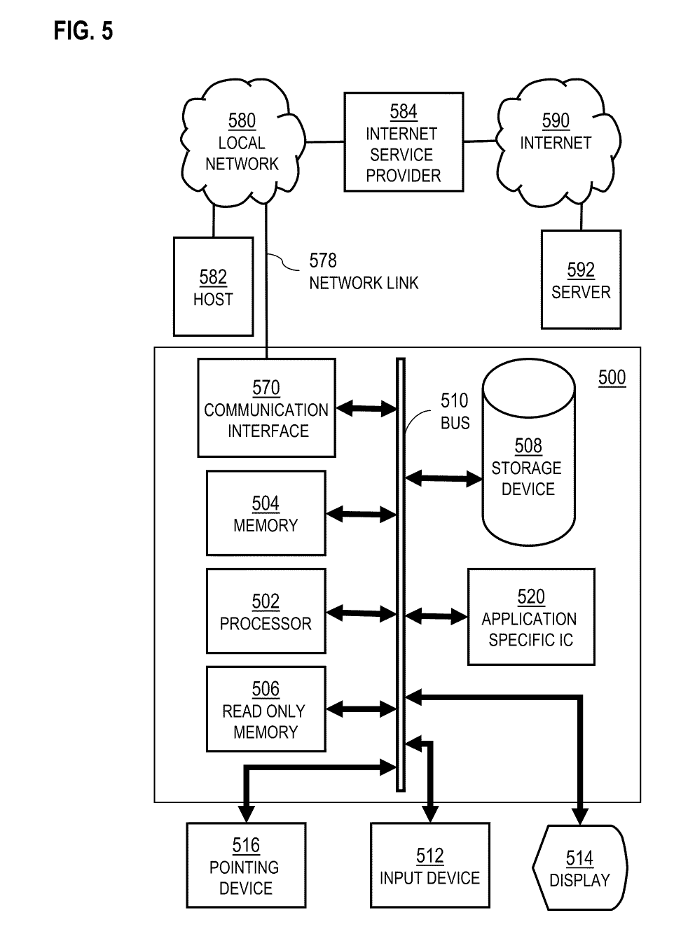

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to presenting content download progress, as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of presenting content download progress.

A bus 510 includes one or more parallel conductors of information so that information is transferred quickly among devices coupled to the bus 510. One or more processors 502 for processing information are coupled with the bus 510.

A processor 502 performs a set of operations on information as specified by computer program code related to presenting content download progress. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for presenting content download progress. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for presenting content download progress, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for downloading content to the UE 101.

The term computer-readable medium is used herein to refer to any medium that participates in providing information to processor 502, including instructions for execution. Such a medium may take many forms, including, but not limited to, non-volatile media, volatile media and transmission media. Non-volatile media include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set 600 upon which an embodiment of the invention may be implemented. Chip set 600 is programmed to present content download progress as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 600, or a portion thereof, constitutes a means for performing one or more steps of presenting content download progress.

In one embodiment, the chip set 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform one or more of the inventive steps described herein to present content download progress. The memory 605 also stores the data associated with or generated by the execution of the inventive steps.

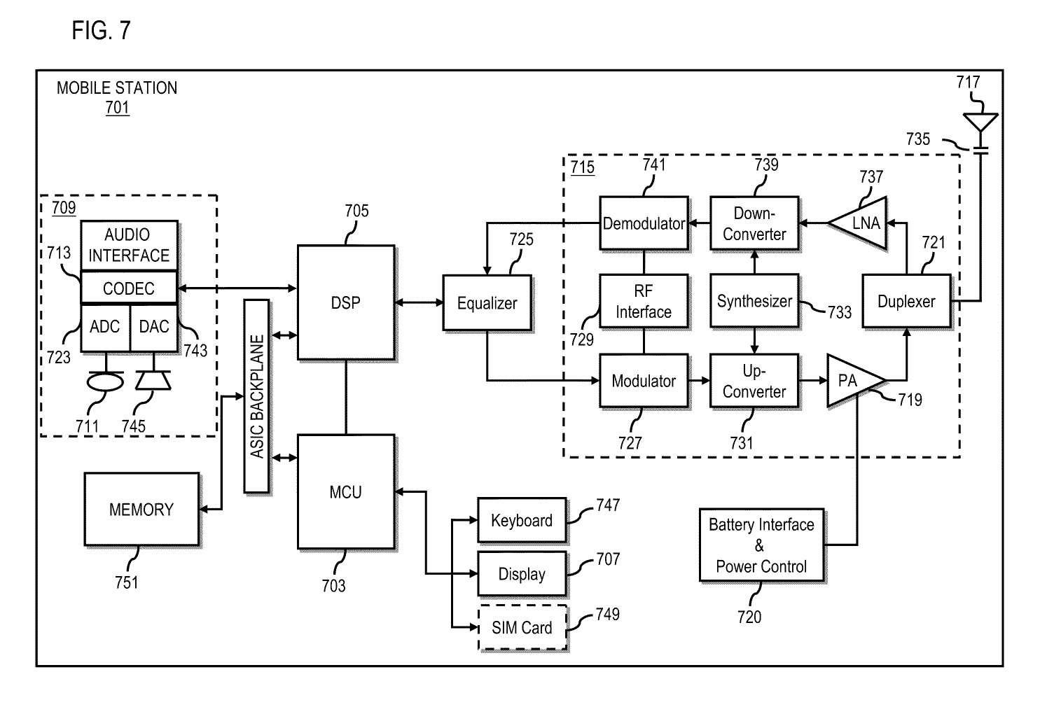

FIG. 7 is a diagram of exemplary components of a mobile terminal (e.g., handset) for communications, which is capable of operating in the system of FIG. 1, according to one embodiment. In some embodiments, mobile terminal 700, or a portion thereof, constitutes a means for performing one or more steps of presenting content download progress. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of presenting content download progress. The display 7 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to present content download progress. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a plurality of layers of information about a specific download of particular content to a local device, wherein the information in the plurality of layers is different from an amount of the particular content;
causing the particular content to be stored progressively into a memory on the local device;
causing a first layer of information to be presented on the local device upon a start of the specific download;
determining an amount of the particular content stored into the memory; and
causing a different second layer of information to be presented progressively on the local device during the specific download based on the amount of the particular content stored into the memory.

2. A method of claim 1, wherein the second layer of information is completely presented at or before completion of the specific download.

3. A method of claim 1, further comprising causing a different third layer of information to be presented progressive during the specific download, which third layer of information is completely presented at or before completion of the specific download and is presented progressive during a time interval different from a time interval during which the second layer of information is presented progressively.

4. A method of claim 5, wherein the time intervals are separated by an event other than start of the specific download and completion of the specific download.

5. A method of claim 4, wherein the event is one of a group of events comprising:
a receipt of a sufficient portion of the particular content to begin rendering the particular content;
a start of side loading at least a portion of the particular content to a local ancillary device;
a start of transcoding the particular content to a format for rendering on the ancillary device;
a delivery of a sufficient portion of transcoded particular content to begin rendering the transcoded particular content on the ancillary device;
an end of transcoding; and
an end of side loading;

6. A method of claim 1, wherein information about the specific download comprises one or more of: content information about the particular content; and context information about the local device or a particular user of the local device.

7. A method of claim 1, wherein one layer of information is a grayscale version of an image related to the particular content and a different layer of information is a color version of the image.

8. A method of claim 1, further comprising,
before the completion of the specific download, determining user input for configuring presentations,
wherein causing the different second layer of information to be presented progressively further comprises causing the different second layer of information to be presented progressively based on the user input.

9. A method of claim 1, wherein the plurality of layers of information about the specific download are obtained from at least one of a remote service, or a previous message from a remote service, or the particular content, or a local device, or a local ancillary device.

10. A method of claim 1, further comprising side loading at least a portion of the particular content to a local ancillary device before completion of the specific download.

11. An apparatus comprising:
at least one processor; and
at least one memory including computer program code,
the at least one memory and the computer program code configured to, with the at least one processor, cause the apparatus to perform at least the following,
determine a plurality of layers of information about a specific download of particular content to the apparatus, wherein the information in the plurality of layers is different from an amount of the particular content;
cause the particular content to be stored progressively into the at least one memory;
initiate presentation of a first layer of information to be presented upon a start of the specific download;
determine an amount of the particular content stored into the at least one memory; and
initiate presentation progressively of a different second layer of information during the specific download based on the amount of the particular content stored into the at least one memory.

12. An apparatus of claim 11, wherein the apparatus is further caused, at least in part, to initiate presentation progressively of a different third layer of information during the specific download, which third layer of information is completely presented at or before completion of the specific download and is presented progressive during a time interval different from a time interval during which the second layer of information is presented progressively.

13. An apparatus of claim 11, wherein information about a specific download comprises one or more of: content information about the particular content; and context information about the apparatus or a particular user of the local device.

14. An apparatus of claim 11, wherein one layer of information is a grayscale version of an image related to the particular content and a different layer of information is a color version of the image.

15. An apparatus of claim 11, wherein the apparatus is further caused, at least in part, to determine user input for configuring presentations before the completion of the specific download, wherein to initiate presentation progressively of the different second layer of information further comprises to initiate presentation progressively of the different second layer of information based on the user input.

16. An apparatus of claim 11, wherein the apparatus is further caused, at least in part, to initiate side loading of at least a portion of the particular content to a local ancillary device before completion of the specific download.

17. An apparatus of claim 11, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
determining a plurality of layers of information about a specific download of particular content to the apparatus, wherein the information in the plurality of layers is different from an amount of the particular content;
causing the particular content to be stored progressively into a memory on the apparatus;
causing a first layer of information to be presented on the local device upon a start of the specific download;
determining an amount of the particular content stored into the memory: and
causing a different second layer of information to be presented progressively on the local device during the specific download based on the amount of the particular content stored into the memory.

19. A computer-readable storage medium of claim 18, wherein the apparatus is caused, at least in part, to further perform presenting progressively a different third layer of information during the specific download, which third layer of information is completely presented at or before completion of the specific download and is presented progressive during a time interval different from a time interval during which the second layer of information is presented progressively.

20. A computer-readable storage medium of claim 18, wherein the apparatus is caused, at least in part, to further perform determining user input for configuring presentations before the completion of the specific download, wherein causing the different second layer of information to be presented progressively further comprises causing the different second layer of information to be presented progressively based on the user input.
